(19) United States
(12) Patent Application Publication
(10) Pub. No.: US 2024/0420729 A1
(43) Pub. Date: Dec. 19, 2024

(54) COMPUTER-IMPLEMENTED METHOD FOR DETECTING ACTIVITY IN AN AUDIO STREAM

(71) Applicant: Elisa Oyj, Helsinki (FI)

(72) Inventors: Ville Ruutu, Helsinki (FI); Jussi Ruutu, Helsinki (FI)

(21) Appl. No.: 18/832,053

(22) PCT Filed: Aug. 17, 2023
(86) PCT No.: PCT/FI2023/050473

§ 371 Date: Jul. 22, 2024

(30) Foreign Application Priority Data
Aug. 31, 2022 (FI) 20225762

(51) Int. Cl. G10L 25/87; G10L 15/22; G10L 15/26

(52) U.S. Cl. CPC G10L 25/87; G10L 15/22; G10L 15/26

(57) ABSTRACT

Disclosed herein is a computer-implemented method for detecting activity in an audio stream. In at least one embodiment, the method includes: obtaining an audio stream; and detecting activity in the audio stream based on detection criteria, where the detection criteria include at least two of: an audio amplitude threshold, where sections of the audio stream with an audio amplitude less than the audio amplitude threshold are classified as inactive; a detection delay defining a time interval of the audio stream during which activity in the audio stream is ignored; a minimum activity duration defining a minimum duration for an active section in the audio stream; and/or a maximum inactivity duration defining a maximum duration of inactivity in the audio stream.

This application is a National Phase entry of International Application No. PCT/FI2023/050473 under § 371 and claims the benefit of Finnish Patent Application No. 20225762, filed Aug. 31, 2022, which is hereby incorporated by reference in its entirety.

### FIELD

The present disclosure relates to audio processing, and more particularly to a computer-implemented method for detecting activity in an audio stream, a computing device, and a computer program product.

### BACKGROUND

An increasing number of organizations are leveraging the power of Automatic Speech Recognition to build automated systems that handle various audio-based interactions, such as telephone and voice-based user interactions. Users are able to handle more and more of their requests by interacting with automated voice-based systems. In such system, it can be beneficial to be able to efficiently detect activity in an audio stream.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective embodiments of the disclosure to provide a computer-implemented method for detecting activity in an audio stream, a computing device, and a computer program product. The foregoing and other objectives are achieved by the features of the independent claims. Further implementation forms are apparent from the dependent claims, the description and the figures.

According to a first aspect, a computer-implemented method for detecting activity in an audio stream comprises: obtaining an audio stream; and detecting activity in the audio stream based on detection criteria, wherein the detection criteria comprise at least two of: an audio amplitude threshold, wherein sections of the audio stream with an audio amplitude less than the audio amplitude threshold are classified as inactive; a detection delay defining a time interval of the audio stream during which activity in the audio stream is ignored; a minimum activity duration defining a minimum duration for an active section in the audio stream; and/or a maximum inactivity duration defining a maximum duration of inactivity in the audio stream. The method can, for example, efficiently detect activity in the audio stream.

In an implementation form of the first aspect, the audio stream corresponds to a voice call.

In another implementation form of the first aspect, the method further comprises, before obtaining the audio stream, providing an audio prompt to a user. The method can, for example, efficiently detect activity in response to the audio prompt.

In another implementation form of the first aspect, the audio prompt requests the user to perform an action. The method can, for example, efficiently detect activity corresponding to the user performing the action.

In another implementation form of the first aspect, method further comprises: identifying when the user has performed the action based on the detecting the activity in the audio stream; and in response to identifying the user has performed the action, performing at least one processing action. The method can, for example, efficiently determine when the user has performed the action and when the audio stream can be processed further.

In another implementation form of the first aspect, the detection delay starts from an end of the audio prompt. The method can, for example, ignore activity that does not correspond to the user performing the action.

In another implementation form of the first aspect, the method further comprises: after providing the audio prompt to the user, starting a polling period, wherein the polling period starts from the end of the audio prompt; and in response to no activity being detected during the polling period, providing another audio prompt to the user. The method can, for example, expedite processing of the voice call by polling the user.

In another implementation form of the first aspect, the method further comprises, before the detecting activity in the audio stream, adjusting the detection delay, the minimum activity duration, the maximum inactivity duration, and/or the polling period according to the action. The method can, for example, adjust the detection delay, the minimum activity duration, the maximum inactivity duration, and/or the polling period to appropriate values according to the action requested from the user.

In another implementation form of the first aspect, the detection criteria comprise at least three of or all of: the audio amplitude threshold, the detection delay, the minimum activity duration, and/or the maximum inactivity duration. The method can, for example, detect activity during the voice call more efficiently using more criteria.

In another implementation form of the first aspect, the detecting activity in the audio stream based on detection criteria comprises: waiting for the detection delay; after the detection delay, continuously comparing the audio amplitude of the audio stream to the audio amplitude threshold; in response to the audio amplitude of the audio stream exceeding the audio amplitude threshold, checking whether the audio amplitude of the audio stream exceeds the audio amplitude threshold for at least the minimum activity duration; and in response to the audio amplitude of the audio stream exceeding the audio amplitude threshold for at least the minimum activity duration, providing an activity indication. The method can, for example, efficiently detect activity during the voice call.

In another implementation form of the first aspect, the method further comprises: in response to the maximum inactivity duration being exceeded without activity being detected in the audio stream, providing a no-activity indication. The method can, for example, expedite processing of the voice call when no activity has been detected.

In another implementation form of the first aspect, the method further comprises: in response to the no-activity indication, providing an inactivity audio prompt to the user via the voice call. The method can, for example, expedite processing of the voice call by providing the inactivity audio prompt to the user.

In another implementation form of the first aspect, the method further comprises: in response to detecting activity in the audio stream, performing a speech-to-text conversion on the audio stream, thus obtaining a transcript of speech data in the audio stream; and performing at least one processing action based at least on the transcript. The method can, for example, process the audio stream more efficiently, since the speech-to-text conversion does not need to be performed on the whole audio stream.

In another implementation form of the first aspect, the method further comprises: identifying an amplitude of noise in the audio stream; and adjusting the audio amplitude threshold according to the amplitude of noise. The method can, for example, efficiently filter noise with an appropriately adjusted audio amplitude threshold.

According to a second aspect, a computing device comprises at least one processor and at least one memory including computer program code, the at least one memory and the computer program code being configured to, with the at least one processor, cause the computing device to perform the method according to the first aspect.

According to a third aspect, a computer program product comprises program code configured to perform the method according to the first aspect when the computer program product is executed on a computer.

Many of the attendant features will be more readily appreciated as they become better understood by reference to the following detailed description considered in connection with the accompanying drawings.

### BRIEF DESCRIPTION OF THE DRAWINGS

In the following, example embodiments are described in more detail with reference to the attached figures and drawings, in which:

FIG. 1 illustrates a flow chart representation of a method according to an embodiment;

FIG. 2 illustrates a schematic representation of activity detection according to a comparative example;

FIG. 3 illustrates a schematic representation of activity detection according to a comparative example;

FIG. 4 illustrates a schematic representation of activity detection according to a comparative example;

FIG. 5 illustrates a schematic representation of activity detection according to an embodiment;

FIG. 6 illustrates a schematic representation of activity detection according to an embodiment;

FIG. 7 illustrates a schematic representation of activity detection according to an embodiment;

FIG. 8 illustrates a flow chart representation of activity detection according to an embodiment; and

FIG. 9 illustrates a schematic representation of a computing device according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilized, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

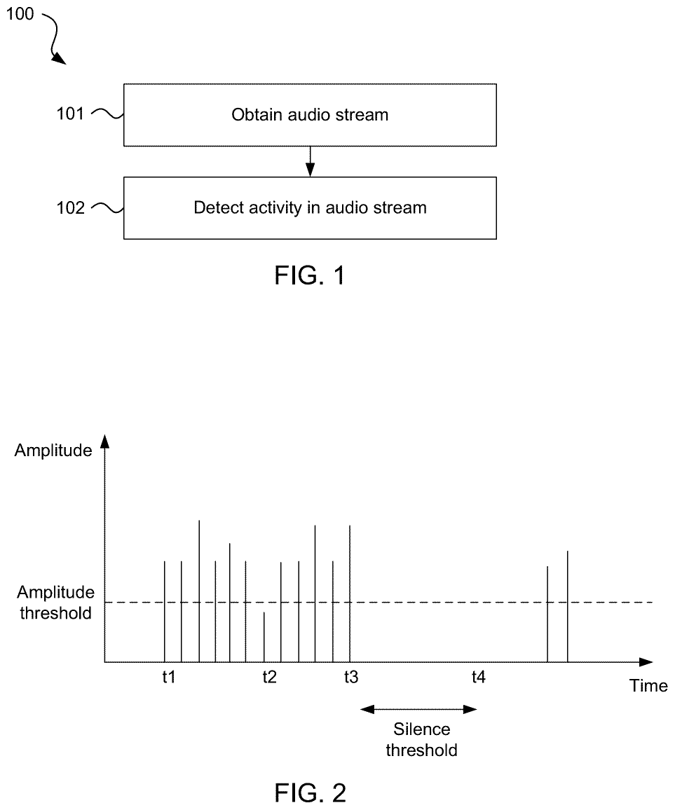

FIG. 1 illustrates a flow chart representation of a method according to an embodiment.

According to an embodiment, a computer-implemented method 100 for detecting activity in an audio stream comprises obtaining 101 an audio stream.

According to an embodiment, the audio stream corresponds to a voice call. The audio stream can comprise, for example, audio of a user calling via a voice call. Alternatively, the audio stream may correspond to a dialog between a user and a device/system/service or to any other voice-based communication.

Herein, activity during the audio stream may refer to any section of the audio stream and/or of the corresponding voice call during which a user speaks.

Herein, a voice call may also be referred to as a call.

Any disclosure herein in relation to a voice call may also apply to any other voice-based interaction such as a dialog between a user and a device/system/service or any other voice-based communication.

The method 100 may further comprise detecting 102 activity in the audio stream based on detection criteria, wherein the detection criteria comprise at least two of: an audio amplitude threshold, wherein sections of the audio stream with an audio amplitude less than the audio amplitude threshold are classified as inactive, a detection delay defining a time interval of the audio stream during which activity in the audio stream is ignored, a minimum activity duration defining a minimum duration for an active section in the audio stream, and/or a maximum inactivity duration defining a maximum duration of inactivity in the audio stream.

The detecting 102 activity in the audio stream may comprise detecting at least one active section of the audio stream.

Herein an active section of the audio stream may refer to any part of the audio stream that is identified as active by the method 100.

In some embodiments, the audio amplitude threshold can be implemented as an inactivity audio amplitude threshold and an activity audio amplitude threshold, wherein sections of the audio stream with an audio amplitude less than the inactivity audio amplitude threshold are classified as inactive sections and sections of the audio stream with an audio amplitude greater than the activity audio amplitude threshold are classified as active. Sections of the audio stream with an audio amplitude greater than the inactivity audio amplitude threshold but less than the activity audio amplitude threshold can be classified as inconclusive.

In some embodiments, the detection delay may start from an instance of time at which listening to the audio stream is started.

In some embodiments, the detection delay may start from an instance of time at which an audio prompt ends.

The method 100 may comprise, for example, after the detection delay, monitoring for sections during which an audio amplitude of the audio stream exceeds the audio amplitude threshold. In response to a duration of a sections during which an audio amplitude of the audio stream exceed the audio amplitude threshold exceeding the minimum activity duration, activity may be detected.

In response to the maximum duration of inactivity in the audio stream being exceeded without activity being detected, processing of the audio call may continue.

The method 100 may utilize activity detection and silence detection in, for example parallel. Activity detection can be used to determine when there is activity in the audio stream, such as when the user is speaking, and silence detection may be used to detect when the audio stream is silent, such when the user has stopped speaking.

According to an embodiment, the detection criteria comprise at least three of or all of: the audio amplitude threshold, the detection delay, the minimum activity duration, and/or the maximum inactivity duration.

For example, the detection criteria may comprise the audio amplitude threshold, the detection delay, and the minimum activity duration or the detection criteria may comprise the audio amplitude threshold, the detection delay, and the maximum inactivity duration or the detection criteria may comprise the audio amplitude threshold, the minimum activity duration, and the maximum inactivity duration or the detection criteria may comprise the detection delay, the minimum activity duration, and the maximum inactivity duration.

According to an embodiment, the method 100 further comprises, in response to detecting activity in the audio stream, performing a speech-to-text conversion on the audio stream, thus obtaining a transcript of speech data in the audio stream, and performing at least one processing action based at least on the transcript.

The at least one processing action may comprise, for example, at least one call processing action.

The method 100 may comprise, for example, performing a speech-to-text conversion on a section of the audio stream that was detected to be an active section. For example, the method 100 may further comprise classifying the transcript and, based on the classification, determining whether a requested action was performed successfully. Thus, processing resources can be saved since the whole audio stream does not need to be transcribed.

The method 100 may improve the user experience of using, for example, an automated audio/call processing system and/or enable different applications for automated audio/call processing systems.

Herein, some disclosure may be described in terms of functionality of a system, such as a voice call processing system. Such disclosure can also be applied to the method 100 and vice versa.

FIG. 2 illustrates a schematic representation of activity detection according to a comparative example.

In the comparative example of FIG. 2, activity in an audio stream corresponding to a voice call is detected using an amplitude threshold and a silence threshold. If amplitude in the voice call is below the threshold amplitude for the duration of the silence threshold, silence is detected. On the other hand, if the amplitude threshold is exceeded, speech is detected. For example, in the comparative example of FIG. 2, amplitude of the voice call is below the amplitude threshold from time instance t3 onwards. At time instance t4, the silence threshold is exceeded. From time instance t1 to time instance t3, speech is detected.

In systems collecting audio inputs from a user, issues may arise if a speech detection similar to the comparative example of FIG. 2 is used. For example, the system may request the user to perform an action which may take a length of time which is difficult to predict. For example, the system may ask the user to obtain a the latest bill sent to the user by a company managing the system. Due to the difficult to predict duration of the task, it may not be beneficial to use an activity detection similar to that illustrated in the comparative example of FIG. 2 to determine when the processing of the call should proceed to the next step. Some issues that may arise are illustrated in the following comparative examples.

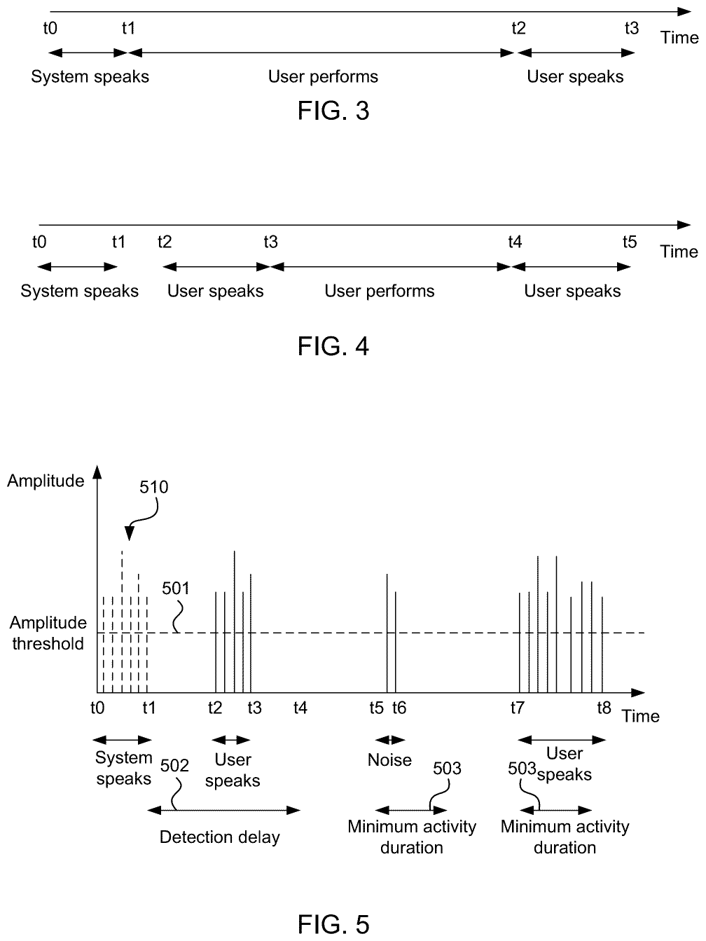

FIG. 3 illustrates a schematic representation of activity detection according to a comparative example.

In the comparative example of FIG. 3, the system speaks between time instances to and t1. The system can, for example, request the user to perform an action. The user can perform the action between time instances t1 and t2 and then inform the system between time instances t2 and t3 that they have performed the action. The duration between time instances t1 and t2 can be long and difficult to predict beforehand.

FIG. 4 illustrates a schematic representation of activity detection according to a comparative example.

In the comparative example of FIG. 4, the system speaks between time instances to and t1. The system can, for example, request the user to perform an action. The user may talk between time instances t2 and t3 in order to confirm that they are going to perform the action. Thus, at time instance t2, the system may detect activity and incorrectly deduce that the user has therefore already performed the action. When, in reality, the user is still performing the action until time instance t4. The user may then speak from time instance t4 to time instance t5 to confirm that they have performed the action.

The issues discussed above may arise, for example, when the system functions as an IT support. The user may call the system and describe an issue with, for example, a printer. The system may ask the user to restart the printer and to indicate whether a light is illuminated on the printer. The time the printer takes to restart can vary significantly or the user may not be located close to the printer etc. Thus, a proper length for the silence threshold may be difficult to find. If the silence threshold is set to be too short, an issue similar to that illustrated in the comparative example of FIG. 4 can arise. On the other hand, if the silence threshold is set to be too long, the user may need to wait unnecessarily, which can worsen the user experience and make processing of the voice call inefficient.

FIG. 5 illustrates a schematic representation of activity detection according to an embodiment.

According to an embodiment, the method 100 further comprises, before obtaining 101 the audio stream, providing an audio prompt 510 to a user via the voice call.

In some embodiments, the method 100 may further comprises, providing the audio prompt 510 to the user after obtaining 101 the audio stream and before detecting 102 activity in the audio stream based on detection criteria.

The audio prompt may be provided via, for example, the voice call. Alternatively, if the user is interacting with a device/system/service using other means than a voice call, the audio prompt can also be provided in some other fashion, such as via a speaker.

For example, in the embodiment of FIG. 5, the system speaks from time instance to to time instance t1 providing an audio prompt 510 to a user.

According to an embodiment, the audio prompt 510 requests the user to perform an action.

According to an embodiment, the method 100 further comprises: identifying when the user has performed the action based on the detecting the activity in the audio stream and, in response to identifying the user has performed the action, performing at least one processing action.

The at least one processing action may comprise, for example, at least one call processing action.

The at least one processing action may comprise any action for processing the audio stream, such as performing speech-to-text conversion on the audio stream or a section of the audio stream, such as an active section of the audio stream, continuing to a next step in a preconfigured voice call processing script, forwarding the voice call to a human operator, and/or any combination thereof.

According to an embodiment, the detection delay 502 starts from an end of the audio prompt 510.

For example, in the embodiment of FIG. 5, the detection delay 502 starts from time instance t1 and ends at a time instance t4. Thus, when the user speak from time instance t2 to time instance t3, the speech is ignored, since this occurs during the detection delay 502 and the user is unlikely to have completed the requested action at that time. Rather, the user probably only acknowledges that they will perform the requested action.

Further, in the embodiment of FIG. 5, there is some noise that exceeds the audio amplitude threshold 501 from time instance t5 to time instance t6. This noise is ignored since the duration of the noise is less than the minimum activity duration 503. From time instance t7 to time instance t8, the user speaks for a period longer than the minimum activity duration 503. Thus, the system can detect the activity in the audio stream during this time period. The system can, for example, continue processing the call corresponding to the audio stream based on the detected activity or the system can perform a speech-to-text conversion on the speech of the user in order to determine whether the user has performed the requested action and continue processing the call if the user has performed the requested action.

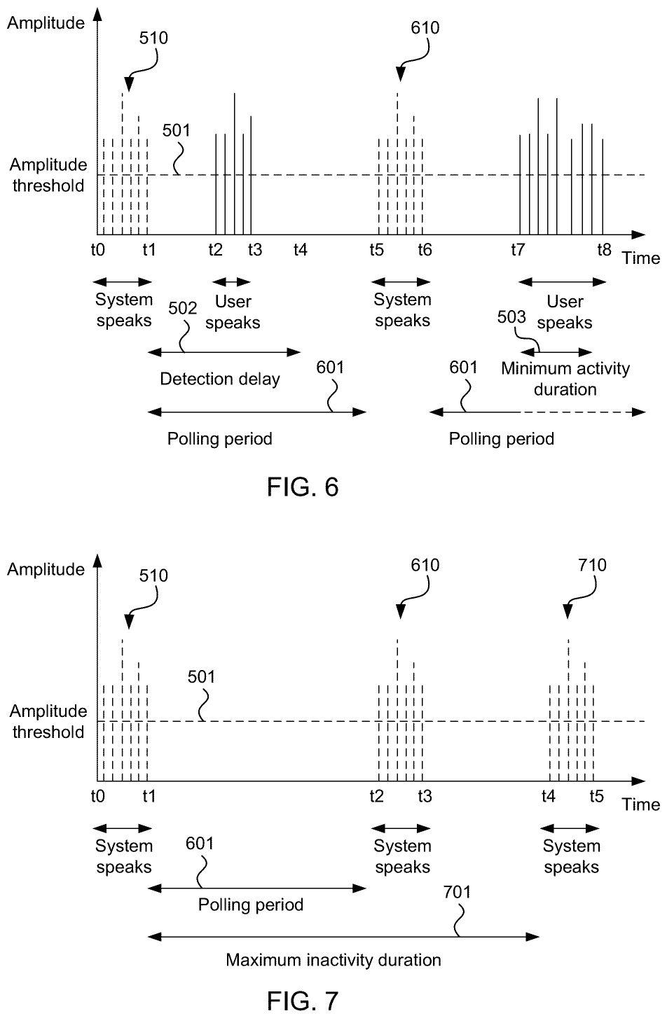

FIG. 6 illustrates a schematic representation of activity detection according to an embodiment.

According to an embodiment, the method further comprises, after providing the audio prompt 510 to the user, starting a polling period 601, wherein the polling period 601 starts from the end of the audio prompt 510 and, in response to no activity being detected during the polling period 601, providing another audio prompt 610 to the user.

The another audio prompt may be provided via, for example, the voice call. Alternatively, if the user is interacting with a device/system/service using other means than a voice call, the another audio prompt can also be provided in some other fashion, such as via a speaker.

For example, in the embodiment of FIG. 6, the system provides an audio prompt 510 (t0-1) and a detection delay 502 (t1-t4) and a polling period 601 (t1-t5) starts at the end of the audio prompt 510. No activity is detected during a polling period 601 due to the user speaking (t2-t3) only during the detection delay 502. Thus, the system provides another audio prompt 610 (t5-t6) after the polling period 601, which starts another polling period 601 (t6 onwards). The another audio prompt 610 can, for example, request the user to announce when the action has been performed. During this polling period 601, the user speaks (t7-t8) for a period longer than the minimum activity duration 503 and thus activity is detected.

According to an embodiment, the method 100 further comprises identifying an amplitude of noise in the audio stream and adjusting the audio amplitude threshold according to the amplitude of noise.

The audio amplitude threshold may be adjusted to be greater than the amplitude of noise so that the noise does not cause triggering of the activity detection. The amplitude of noise can be identified by, for example, measuring amplitude of noise during the voice call when the user is not speaking.

According to an embodiment, the method 100 further comprises, before the detecting activity in the audio stream, adjusting the detection delay, the minimum activity duration, the maximum inactivity duration, and/or the polling period according to the action.

The detection delay, the minimum activity duration, the maximum inactivity duration, and/or the polling period may be adjusted based on, for example, contexts of the action. The detection delay, the minimum activity duration, the maximum inactivity duration, and/or the polling period may be adjusted based on, for example, previously obtained information about how long a specific action should take to perform. For example, the action may comprise the user checking a serial number of a computer, which may be a quick action to perform, or the action may comprise the user restarting a computer, which may take longer to perform.

Additionally or alternatively, the detection delay, the minimum activity duration, the maximum inactivity duration, and/or the polling period may be adjusted based on, for example, previously obtained on statistical information collected from, for example, previously processed voice calls.

Additionally or alternatively, the detection delay, the minimum activity duration, the maximum inactivity duration, and/or the polling period may be adjusted based on, for example, information obtained from user surveys and/or user feedback. For example, after processing the voice call, user feedback can be requested if, for example, the maximum inactivity duration is exceeded during the voice call.

The minimum activity duration may be adjusted based on, for example, the expected response from the user based on the requested action. For example, if the user is requested to check if a light on a device is blinking, the expected answer is either “yes” or “no”. Thus, the minimum activity duration should be short. On the other hand, if a more elaborate answer is to be expected, the minimum activity duration should be longer.

The audio amplitude threshold, the detection delay, and/or the minimum activity duration can be adjust based on, for example, historical information. The historical information may comprise, for example, a plurality of voice samples. The voice samples may be from, for example, previous audio streams of interactions, such as voice calls or from commands of voice-based user interfaces. The historical information may comprise, for example, statistical information, such as averages, rolling averages, Kalman filtering, etc., from such voice samples. For example, statistical information may be collected about an average time a user takes to perform an action.

The method 100 may further comprise identifying the user. The user may be identified based on, for example, their phone number or other information. The method 100 may further comprise setting the audio amplitude threshold, the detection delay, and/or the minimum activity duration based on the identified user. For example, a user-specific audio amplitude threshold, a user-specific detection delay, and/or a user-specific minimum activity duration can be stored in a database.

FIG. 7 illustrates a schematic representation of activity detection according to an embodiment.

According to an embodiment, the method 100 further comprises, in response to the maximum inactivity duration 701 being exceeded without activity being detected in the audio stream, providing a no-activity indication.

The no-activity indication may comprise, for example, any signal/indication/indicator provided by a system performing the method 100 within the system or from the system to, for example, another system. The system may perform various processing operations, such as those disclosed herein, in response to the no-activity indication.

According to an embodiment, the method 100 further comprises, in response to the no-activity indication, providing an inactivity audio prompt 710 to the user.

The inactivity audio prompt may be provided via, for example, the voice call. Alternatively, if the user is interacting with a device/system/service using other means than a voice call, the inactivity audio prompt can also be provided in some other fashion, such as via a speaker.

The inactivity audio prompt 710 can, for example, indicate to the user that the processing of the call will continue.

For example, in the embodiment of FIG. 7, the system provides an audio prompt 510 (t0-t1) and a detection delay, a polling period 601 (t1-t2), and a maximum inactivity duration 701 (t1-t4) starts at the end of the audio prompt 510. The detection delay is not illustrated in the embodiment of FIG. 7. No activity is detected during the polling period 601. Thus, the system provides another audio prompt 610 (t2-t3) after the polling period 601, which starts another polling period. The second polling period is not illustrated in the embodiment of FIG. 7. Since the maximum inactivity duration 701 is exceeded without activity in the audio stream, the system provides an inactivity audio prompt 710 (t4-t5) after the maximum inactivity duration 701. The system can also proceed processing the call after the maximum inactivity duration 701.

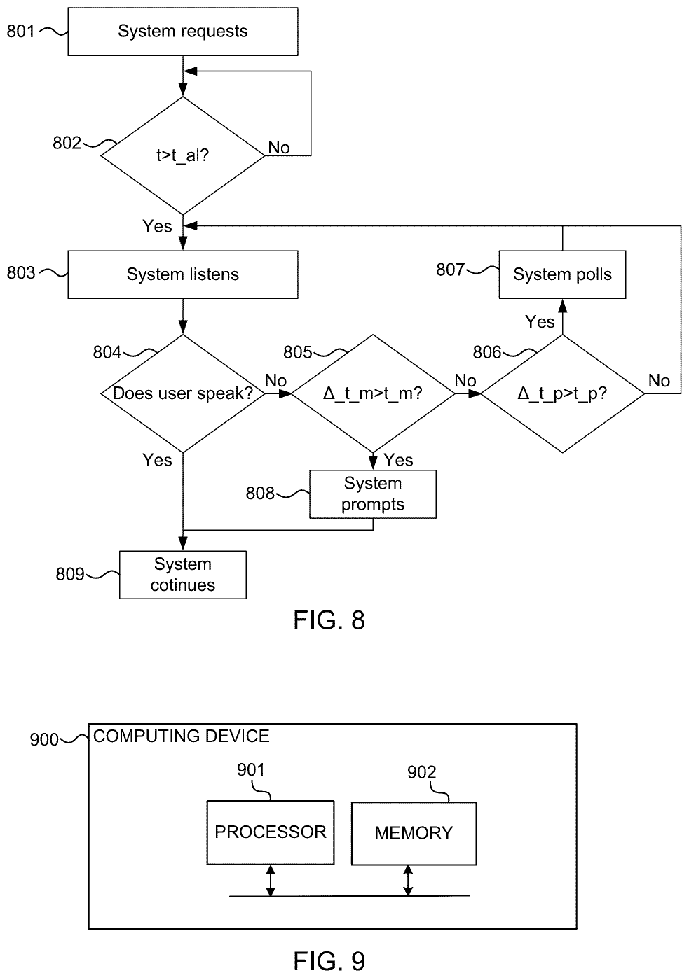

FIG. 8 illustrates a flow chart representation of activity detection according to an embodiment.

The system requests 801 the user to perform an action and then waits for the detection delay t_a1 by repeatedly checking 802 whether the detection delay t_a1 has passed.

After the detection delay t_a1 has passed, the system can listen 803 to the audio stream and determine 804 whether the user speaks. If the user speaks, the system can continue 809 processing the call. If the user does not speak, the system can check 805 whether the maximum duration of inactivity Δ_t_m has passed. If the maximum duration of inactivity Δ_t_m has passed, the system can prompt 808 the user with the inactivity audio prompt via the voice call and continue 809 processing the call. If the maximum duration of inactivity has not passed, the system can check 806 if the polling period Δ_t_p has passed. If the polling period Δ_t_p has passed, the system can poll 807 the user by providing another audio prompt and return to listening 803 to the call. If the polling period has not passed, the system can return to listening 803 to the call.

According to an embodiment, the detecting 102 activity in the audio stream based on detection criteria comprises: waiting for the detection delay; after the detection delay, continuously comparing the audio amplitude of the audio stream to the audio amplitude threshold; in response to the audio amplitude of the audio stream exceeding the audio amplitude threshold, checking whether the audio amplitude of the audio stream exceeds the audio amplitude threshold for at least the minimum activity duration; and in response to the audio amplitude of the audio stream exceeding the audio amplitude threshold for at least the minimum activity duration, providing an activity indication.

The activity indication and/or the no-activity indication can be used to, for example, choose an appropriate call processing action to be performed. For example, activity indication may correspond to situations in which the user has performed the requested action. Thus, the call can be processed accordingly. For example, if the user was requested to retrieve some information, this information can be used for further processing of the call. On the other hand, the no-activity indication can correspond to situations in which the user has not performed the requested action, and this should be taken into account when processing the call. For example, if the user was requested to retrieve some information, this information may not be available for further processing of the call.

The continuously comparing the audio amplitude of the audio stream to the audio amplitude threshold may comprise, for example, consecutively comparing each audio sample of the audio stream to the audio amplitude threshold.

FIG. 9 illustrates a schematic representation of a computing device according to an embodiment.

According to an embodiment, a computing device 900 comprises at least one processor 901 and at least one memory 902 including computer program code, the at least one memory 902 and the computer program code configured to, with the at least one processor 901, cause the computing device 900 to perform the method 100.

The computing device 900 may comprise at least one processor 901. The at least one processor 901 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The computing device 900 may further comprise a memory 902. The memory 902 may be configured to store, for example, computer programs and the like. The memory 902 may comprise one or more volatile memory devices, one or more non-volatile memory devices, and/or a combination of one or more volatile memory devices and nonvolatile memory devices. For example, the memory 902 may be embodied as magnetic storage devices (such as hard disk drives, magnetic tapes, etc.), optical magnetic storage devices, and semiconductor memories (such as mask ROM, PROM (programmable ROM), EPROM (erasable PROM), flash ROM, RAM (random access memory), etc.).

The computing device 900 may further comprise other components not illustrated in the embodiment of FIG. 9. The computing device 900 may comprise, for example, an input/output bus for connecting the computing device 900 to other devices. Further, a user may control the computing device 900 via the input/output bus.

When the computing device 900 is configured to implement some functionality, some component and/or components of the computing device 900, such as the at least one processor 901 and/or the memory 902, may be configured to implement this functionality. Furthermore, when the at least one processor 901 is configured to implement some functionality, this functionality may be implemented using program code comprised, for example, in the memory.

The computing device 900 may be implemented at least partially using, for example, a computer, some other computing device, or similar.

The method 100 and/or the computing device 900 may be utilized in, for example, automatic speech recognition (ASR) application such as in a so-called voicebot. A voicebot may be configured to obtain information from users by, for example, phone and convert the voice information into text information using ASR. The method 100 may be used to detect active sections in a voice call and the active sections can be processed using ASR. The voicebot may further be configured to further process, such as classify, text information obtained via ASR. The voicebot can, for example, ask questions about, for example, basic information from a customer in a customer service situation over the phone, obtain the answers using ASR and the method 100, and save the information in a system. Thus, the customer service situation can be made more efficient and user experience can be improved.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method (100) for detecting activity in an audio stream, the method comprising:
obtaining (101) an audio stream; and
detecting (102) activity in the audio stream based on detection criteria, wherein the detection criteria comprise at least two of:
an audio amplitude threshold (501), wherein sections of the audio stream with an audio amplitude less than the audio amplitude threshold are classified as inactive;
a detection delay (502) defining a time interval of the audio stream during which activity in the audio stream is ignored;
a minimum activity duration (503) defining a minimum duration for an active section in the audio stream; and/or
a maximum inactivity duration (701) defining a maximum duration of inactivity in the audio stream.

2. The computer-implemented method (100) according to claim 1, wherein the audio stream corresponds to a voice call.

3. The computer-implemented method (100) according to claim 1 or claim 2, the method further comprising, before obtaining the audio stream, providing an audio prompt (510) to a user.

4. The computer-implemented method (100) according to claim 3, wherein the audio prompt (510) requests the user to perform an action.

5. The computer-implemented method (100) according to claim 4, the method further comprising:
identifying when the user has performed the action based on the detecting the activity in the audio stream; and
in response to identifying the user has performed the action, performing at least one processing action.

6. The computer-implemented method (100) according to any of claims 3-5, wherein the detection delay (502) starts from an end of the audio prompt (510).

7. The computer-implemented method (100) according to any of claims 3-6, the method further comprising:
after providing the audio prompt (510) to the user, starting a polling period (601), wherein the polling period (601) starts from the end of the audio prompt (510); and
in response to no activity being detected during the polling period (601), providing another audio prompt (610) to the user.

8. The computer-implemented method (100) according to any of claims 3-7, the method further comprising, before the detecting activity in the audio stream, adjusting the detection delay (502), the minimum activity duration (503), the maximum inactivity duration (701), and/or the polling period (601) according to the action.

9. The computer-implemented method (100) according to any preceding claim, wherein the detection criteria comprise at least three of or all of: the audio amplitude threshold (501), the detection delay (502), the minimum activity duration (503), and/or the maximum inactivity duration (701).

10. The computer-implemented method (100) according to any preceding claim, wherein the detecting activity in the audio stream based on detection criteria comprises:
waiting for the detection delay (502);
after the detection delay (502), continuously comparing the audio amplitude of the audio stream to the audio amplitude threshold (501);
in response to the audio amplitude of the audio stream exceeding the audio amplitude threshold (501), checking whether the audio amplitude of the audio stream exceeds the audio amplitude threshold for at least the minimum activity duration (503); and
in response to the audio amplitude of the audio stream exceeding the audio amplitude threshold (501) for at least the minimum activity duration (503), providing an activity indication.

11. The computer-implemented method (100) according to any preceding claim, the method further comprising:
in response to the maximum inactivity duration (701) being exceeded without activity being detected in the audio stream, providing a no-activity indication.

12. The computer-implemented method (100) according to claim 11, the method further comprising:
in response to the no-activity indication, providing an inactivity audio prompt (710) to the user.

13. The computer-implemented method (100) according to any preceding claim, the method (100) further comprising:
in response to detecting activity in the audio stream, performing a speech-to-text conversion on the audio stream, thus obtaining a transcript of speech data in the audio stream; and
performing at least one processing action based at least on the transcript.

14. The computer-implemented method (100) according to any preceding claim, the method (100) further comprising:
identifying an amplitude of noise in the audio stream; and
adjusting the audio amplitude threshold (501) according to the amplitude of noise.

15. A computing device (900), comprising at least one processor (901) and at least one memory (902) including computer program code, the at least one memory (902) and the computer program code configured to, with the at least one processor (901), cause the computing device (900) to perform the method (100) according to any preceding claim.

16. A computer program product comprising program code configured to perform the method according to any of claims 1-14 when the computer program product is executed on a computer.
